(19) United States
(12) Patent Application Publication
(10) Pub. No.: US 2024/0419854 A1
(43) Pub. Date: Dec. 19, 2024

(54) MODELING METHOD FOR LOW-LOSS TRANSPORT TECHNOLOGY WITH DIRECTIED FORCE APPLICATION AND SLOW LANDING

(71) Applicants: HAINAN UNIVERSITY, HAIKOU (CN); QINGDAO AGRICULTURAL UNIVERSITY, QINGDAO (CN)

(72) Inventors: RANBING YANG, HAIKOU (CN); ZHIGUO PAN, QINGDAO (CN); WENWEN GUO, HAIKOU (CN); CHUNJIANG ZHAO, HAIKOU (CN); TAO WANG, HAIKOU (CN); HUAN ZHANG, QINGDAO (CN); JIAN ZHANG, HAIKOU (CN); WEIJING WANG, QINGDAO (CN)

(21) Appl. No.: 18/677,762

(22) Filed: May 29, 2024

(30) Foreign Application Priority Data
Jun. 13, 2023 (CN) 202310697898.1

(51) Int. Cl. G06F 30/17; G06F 30/15; G06F 119/14

(52) U.S. Cl. CPC G06F 30/17; B65G 17/083; G06F 2119/14

(57) ABSTRACT

A modeling method for a low-loss transport technology with directed force application and slow landing is provided, including determining relevant parameters, such as friction coefficients between a crop and grid bars, performing theoretical analysis, modeling an auxiliary device for simulating a motion trail of the crop, and modeling a three-dimensional diagram according to structural parameters. In this way, the crop and the soil are effectively separated, and situations, such as high surface scratching rate and internal bruising caused due to a motion manner of a conventional low-loss transport device with directed force application and slow landing, in a separation process of the crop and the soil is greatly reduced.

### TECHNICAL FIELD

The present disclosure relates to a technical field of harvesting crops with surfaces easy to be scratched, and in particular to a modeling method for a low-loss transport technology with directed force application and slow landing.

### BACKGROUND

Currently, even though an agricultural technology level is continuously improved in China and a mechanization technology of agricultural production tends to be mature, a harvesting technology still has some defects, such as high crop damage rates and short crop storage periods, so that farmer incomes are low. In an aspect of reducing crop damage rates, experts have done many researches, mainly including researches on S-shaped multistage transport devices with rubber sleeves sleeved on transport grid bars, burr type low-loss transport devices with directed force application and slow landing, roller-type transport and separation devices, etc., the above devices are all capable of relieving impact force brought by falling of crops to prevent the crops from internal bruising caused by collision. However, conventional low-loss transport devices with directed force application and slow landing does not change a motion form with the crops, so that a problem that the conventional low-loss transport devices drag the crops to cause surface scratching of the crops is not solved, a crop surface scratching rate and a crop damage rate are still high, in order to reduce problems, such as the high crop surface scratching rate caused by a moving manner in a separation process of the crops and soil, the present disclosure provides a modeling method for a low-loss transport technology with directed force application and slow landing.

### SUMMARY

A modeling method for a low-loss transport technology with directed force application and slow landing includes following steps.

S1: determining relevant parameters specified by a potato harvesting standard.

S2: performing theoretical analysis, and determining structural parameters of a low-loss transport device with directed force application and slow landing.

S3: modeling an auxiliary device for simulating a motion trail of a crop.

S4: modeling a modeling main body, auxiliary wheels, grid bars, and belts in sequence to form a low-loss transport device with directed force application and slow landing, and modeling a driving device at a rear portion of the low-loss transport device with directed force application and slow landing to drive the low-loss transport device with directed force application and slow landing to run.

Furthermore, the S2 includes dividing the low-loss transport device with directed force application and slow landing into three segments to respectively perform the theoretical analysis on the crop. The theoretical analysis includes stress analysis and speed analysis. The three segments include a first segment, a second segment, and a third segment, the first segment is from a front driven wheel to the modeling main body, the second segment is from the modeling main body to the auxiliary wheels, and the third segment is from the auxiliary devices to the driving device.

Furthermore, the stress analysis and the speed analysis are as follows.

In the first segment, a component velocity of the crop in a horizontal direction is slightly higher than a forward speed of the low-loss transport device with directed force application and slow landing, a vertical movement distance of the crop is not greater than a maximum height of falling of the crop, and stress on the crop is balanced. An inclination angle of the modeling main body of the low-loss transport technology with directed force application and slow landing is the same as an inclination angle of a digging shovel.

In the second segment, a movement of the crop from the first segment to the second segment is an oblique projectile movement, and at a moment when the crop is in contact with the low-loss transport device with directed force application and slow landing, a resultant velocity direction of the crop is vertically downward and the stress on the crop is balanced.

Furthermore, in that at the moment when the crop is in contact with the low-loss transport device with directed force application and slow landing, the resultant velocity direction of the crop is vertically downward and the stress on the crop is balanced, a speed difference between an instantaneous resultant velocity of the crop falling on the low-loss transport device with directed force application and slow landing and a transporting velocity of the low-loss transport device with directed force application and slow landing is not greater than 0.02 m/s.

Furthermore, in the stress analysis and the speed analysis performed on the second segment, the transporting velocity of the low-loss transport device with directed force application and slow landing is transported downward along an inclination angle, and plays a role in buffering the crop.

In the third segment, the crop moves along with the low-loss transport device with directed force application and slow landing, the stress on the crop is balanced, and a height between a highest point of the crop in the third segment and a lowest point of the crop of a next step is within an allowable range of falling damage.

Furthermore, the S3 includes analyzing the motion trail of the crop, and modeling the modeling main body.

Furthermore, in the analyzing the motion trail of the crop, when the crop passes through the first segment into the second segment, the movement of the crop is the oblique projectile movement, and magnitudes and directions of an initial speed and a final speed of the oblique projectile movement depend on inclinations of the first segment and the second segment.

Furthermore, in the modeling the modeling main body, when the crop passes through the first segment into the second segment, a motion radian of the low-loss transport device with directed force application and slow landing satisfies the motion trail of the crop, and the motion radian of the low-loss transport device with directed force application and slow landing is achieved by providing modeling main body auxiliary wheels, and an outer contour curve of each of the modeling main body auxiliary wheels in contact with the belts is the same as the motion trail of the crop.

Furthermore, in that the motion radian of the low-loss transport device with directed force application and slow landing is achieved by providing the modeling main body auxiliary wheels, three modeling main body auxiliary wheels are provided, a diameter of an outer wheel of each of the modeling main body auxiliary wheels is less than a diameter of an outer wheel of each of the auxiliary wheels of the low-loss transport device with directed force application and slow landing, and the diameter of the outer wheel of each of the modeling main body auxiliary wheels approximately three quarters of the diameter of the outer wheel of each of the auxiliary wheels of the low-loss transport device with directed force application and slow landing.

Furthermore, in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, a pitch of the driving device is 45 mm and is adapted to a pitch of the low-loss transport device with directed force application and slow landing.

Furthermore, in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, two belts are disposed in the low-loss transport device with directed force application and slow landing to form a belt unit, and a plurality of the grid bars are disposed on an outer side of the belt unit at equal intervals, a fixing wheel of the low-loss transport device with directed force application and slow landing is disposed at a first side of an interior of the belt unit, and a driving wheel is disposed at a second side of the interior of the belt unit away from the fixing wheel of the low-loss transport device with directed force application and slow landing.

Furthermore, in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, the auxiliary wheels are disposed on an inner side and an outer side of the low-loss transport device with directed force application and slow landing, and a supporting surface of each of the auxiliary wheels is parallel to the belts.

Furthermore, in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, a trajectory formed between the auxiliary wheels is the same as a curve of a movement of the crop on a surface of the low-loss transport device with directed force application and slow landing.

Furthermore, in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, the grid bars are made of round steel 11/55CrSi, the belts are made of canvas filler rubber, a covering glue tensile strength of the belts is greater than or equal to 25 MPa, a stretching rate of the belts is greater than or equal to 500%, a Schopper abrasion of the belts is less than or equal to 100 mm³, an adhesion force of belts is greater than or equal to 10 N/M, the belts are not aged for one year under sunlight and has a pitch of 45 mm. The belts and the grid bars are connected by a pin shaft assembly in a riveting process to form the low-loss transport device with directed force application and slow landing.

### BRIEF DESCRIPTION OF DRAWINGS

Specific implementations are further described below with reference to accompanying drawings, in which:

FIG. 1 is an overall schematic flow chart of a modeling method for a low-loss transport technology with directed force application and slow landing according to one embodiment of the present disclosure.

FIG. 2 is a schematic diagram of stress analysis of a crop in the modeling method for the low-loss transport technology with directed force application and slow landing according to one embodiment of the present disclosure.

FIG. 3 is a schematic diagram of speed analysis of the crop in the modeling method for the low-loss transport technology with directed force application and slow landing according to one embodiment of the present disclosure.

FIG. 4 is a three-dimensional schematic diagram of a low-loss transport device with directed force application and slow landing.

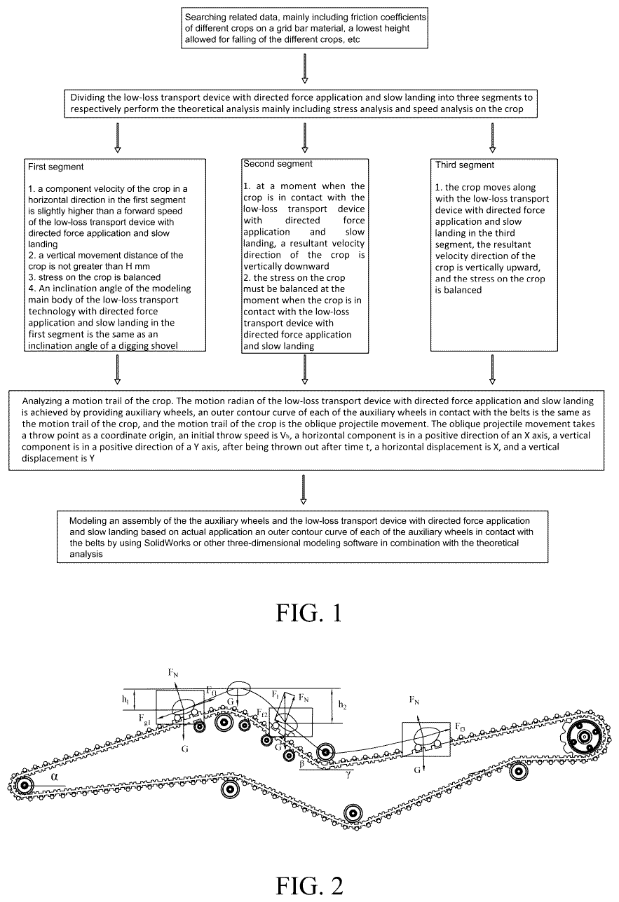

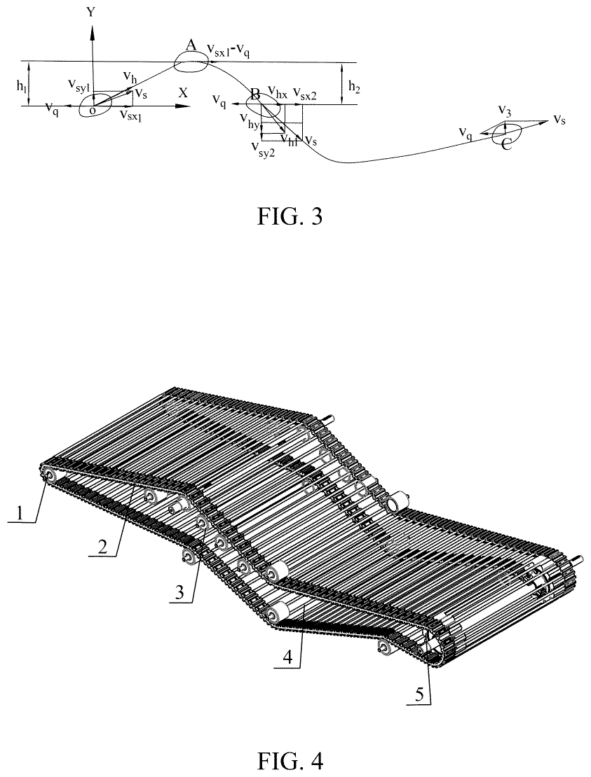

### REFERENCE NUMERALS IN THE DRAWINGS

1. fixing wheel; 2. belt; 3. auxiliary wheel; 4. grid bar; 5. driving wheel.

The present disclosure is further described in detail below with reference to the accompanying drawings.

### DETAILED DESCRIPTION

Specific embodiments of the present disclosure are as follows.

The present disclosure provides a modeling method for a low-loss transport technology with directed force application and slow landing, including a research method of a push-type separation technology with low loss, specific steps of which are as follows.

S1: determining relevant parameters.

Specifically, friction coefficients of different crops on a grid bar material, a lowest height allowed for falling of the different crops, and a maximum forward speed when pulling a tractor during harvesting are determined, the grid bar material is generally 65 manganese steel and rubber material, a minimum friction coefficient and a lowest height allowed for the falling of the different crops are selected.

S2: performing theoretical analysis, and determining structural parameters of a low-loss transport device with directed force application and slow landing.

Specifically, a modeling device of the low-loss transport technology with directed force application and slow landing is divided into three segments to respectively perform the theoretical analysis on a crop. The three segments include a first segment, a second segment, and a third segment, the theoretical analysis includes stress analysis and speed analysis, so as to ensure that a movement of the crop is an oblique projectile movement that the crop passes through an excavating device and moves to the low-loss transport device with directed force application and slow landing and passes through the first segment to the second segment, a direction an instantaneous resultant velocity of the crop falling on the low-loss transport device with directed force application and slow landing is vertically downward, and finally, the crop synchronously moves along with the low-loss transport device with directed force application and slow landing, a height of vertical falling of the crop vertically not exceed a minimum height of falling damage, so that the crop is separated from the soil, and a transporting velocity of the low-loss transport device with directed force application and slow landing and inclination angles of the first segment, the second segment, and the third segment are determined.

S3: performing the theoretical analysis on a motion trail of the crop moving from the first segment to the second segment according to the S2, and modeling a transition position from the first segment to the second segment, so as to effectively buffer a directed force falling on the low-loss transport device with directed force application and slow landing.

S4: modeling a three-dimensional diagram.

Specifically, the three-dimensional diagram is modeled according to the structural parameters determined in the S2 by using SolidWorks or other three-dimensional modeling software.

The S1 includes following steps.

S1.1: static friction factors of the crop on the 65 manganese steel and the rubber material are respectively μ₁ and μ₂, and μ_{1<}μ₂; a minimum friction coefficient μ is selected as a calculation basis; a weight of the crop is Mg; a maximum movement distance of the crop in a vertical direction of the low-loss transport device with directed force application and slow landing is less than or equal to H mm, and if the maximum movement distance of the crop in the vertical direction of the low-loss transport device with directed force application and slow landing exceed H mm, surfaces of the crop may be scratched or internal bruising of the crop may be caused due to collision between the crop and the grid bars.

S1.2: a highest speed allowed for the tractor to harvest the crop is Vg, on a premise of ensuring that crops with surfaces easy to be scratched is good, for avoiding increase of a crop damage rate and improving a separation effect of the crop and soil is improved, a ratio of the forward speed of the tractor to a rotation speed of low-loss transport device with directed force application and slow landing is generally 0.8-2.5, inclination angles between resultant velocities of the first segment, the second segment, and the third segment respectively with a horizontal plane are [symbol] , σ, and δ, respectively, and the transporting velocity of the low-loss transport device with directed force application and slow landing is νₛ.

The S2 includes following steps.

S2.1: the stress analysis and the speed analysis are respectively performed on the crop in the first segment, and since there is a transition segment with the excavating device in the first segment, a component velocity of the crop in a horizontal direction in the first segment is slightly higher than a forward speed of the low-loss transport device with directed force application and slow landing, a vertical movement distance of the crop is not greater than H mm, stress on the crop is balanced. An inclination angle of the modeling main body of the low-loss transport technology with directed force application and slow landing in the first segment is the same as an inclination angle of a digging shovel, and the stress analysis and the speed analysis perform on the crop in the first segment is as follows.

$$mg sin α + {F}_{g 1} - {F}_{f 1} = 0 \qquad Formula ( 1 )$$

$${F}_{N} - mg cos α = 0 \qquad Formula ( 2 )$$

$${F}_{f} = µmgcos α \qquad Formula ( 3 )$$

$${v}_{sx 1} = {v}_{s} cos α \qquad Formula ( 4 )$$

$${v}_{sy 1} = {v}_{s} sin α \qquad Formula ( 5 )$$

$$θ = arc tan \frac{{v}_{s} sin α}{{v}_{s} cos α - {v}_{q}} \qquad Formula ( 6 )$$

$${v}_{sx 1} - {v}_{q} = \sqrt{{( {v}_{s} sin α )}^{2} + {( {v}_{s} cos α - {v}_{q} )}^{2}} cos ( arc tan \frac{{v}_{s} sin α}{{v}_{s} cos α - {v}_{q}} ) \qquad Formula ( 7 )$$

$${v}_{sx 1} - {v}_{q} > 0 \qquad Formula ( 8 )$$

F_{g1} is an inertial force of a single crop that is newly excavated to the modeling main body of the low-loss transport technology with directed force application and slow landing.

F_{f1} is a static friction force of the single crop to the grid bars.

F_{N} is a supporting force of the grid bars to the single crop.

m is a quality of the single crop.

ν_{q} is the forward speed of low-loss transport device with directed force application and slow landing.

νₛ is a backward transporting velocity of the low-loss transport device with directed force application and slow landing.

ν_{sy1} is a component velocity of the transporting velocity in a vertical direction of the first segment.

νₛₓ₁ is a component velocity of the transporting velocity in a horizontal direction of the first segment.

In the first segment, the inclination angle satisfies following condition:

$$α \leq arc cos \frac{\sqrt{2} {F}_{g 1}}{2 mg} - \frac{π}{4} .$$

In the first segment, the transporting velocity satisfies following condition:

$$\sqrt{{( {v}_{s} sin α )}^{2} + {( {v}_{s} cos α - {v}_{q} )}^{2}} cos ( arc tan \frac{{v}_{s} sin α )}{{v}_{s} cos α - {v}_{q}} ) > 0.$$

S2.2: the S2.2 is a main step of the modeling method for the low-loss transport technology with directed force application and slow landing, when harvesting the crop, after the crop undergoes a stage of using the excavating device, a transition stage from the excavating device to the low-loss transport device with directed force application and slow landing (the first segment), the crop enters the send segment and undergoes a second stage of separating with the soil, the second stage is also the most easy stage that causes the falling damage on the crop, and if there is a willing to reduce the falling damage on the crop at the greatest extent, a resultant velocity direction of the crop must be vertically downward and the stress on the crop must be balanced at the moment when the crop is in contact with the low-loss transport device with directed force application and slow landing.

For the stress analysis and the speed analysis respectively performed on the crop in the second segment, a movement of the crop from the first segment to the second segment is the oblique projectile movement, and the crop only bear its own gravity in the movement; along with oblique projectile and falling of the crop, the low-loss transport device with directed force application and slow landing is transported downward along an inclination angle thereof, so that a speed of the crop falling on the low-loss transport device with directed force application and slow landing is buffered. At the moment the crop is in contact with the low-loss transport device with directed force application and slow landing, a resultant velocity ν2 is vertically downward and the stress on the crop is balanced, the crop is not dragged, so that there is no surface scratching happened on the crop. After the crop falls on the low-loss transport device with directed force application and slow landing and moves along with the low-loss transport device with directed force application and slow landing, the crop has a vertical downward movement trend, and a downward movement of the low-loss transport device with directed force application and slow landing and the vertical downward movement trend of the crop are buffered, so that there is no impact brought by a conventional low-loss transport device with directed force application and slow landing. In the second segment, an inclination angle σ between the resultant velocity direction and a horizontal direction is 90°, and an inclination angle between the νₕ and the horizontal direction is ξ.

$$mg sin β - µmgcos β = 0 \qquad Formula ( 9 )$$

$$mg cos β - {F}_{N} = 0 \qquad Formula ( 10 )$$

$${v}_{q} = {v}_{sx 2} + {v}_{hx} \qquad Formula ( 11 )$$

$${v}_{sx 2} = {v}_{s} cos β \qquad Formula ( 12 )$$

$${h}_{2} = \frac{{( {v}_{s} cos α - {v}_{q} )}^{2} {tan}^{2} ξ}{2 g} \qquad Formula ( 13 )$$

$${v}_{2} = {v}_{hy} + {v}_{sy 2} \qquad Formula ( 14 )$$

νₛₓ₂ is a component velocity of the transporting velocity in the horizontal direction of the second segment.

νₕₓ is a component velocity of the resultant velocity in the horizontal direction of the first segment.

After calculation, the inclination angle of the second segment satisfies following condition:

$$β \leq arc tan μ .$$

A maximum distance of a vertical upward-projectile movement of the crop on the low-loss transport device with directed force application and slow landing satisfies following condition:

$$\frac{{( {v}_{s} cos α - {v}_{q} )}^{2} {tan}^{2} ξ}{2 g} \leq H .$$

S2.3: after the crop falls on the low-loss transport device with directed force application and slow landing in the second segment, the crop moves along with the low-loss transport device with directed force application and slow landing in the third segment, and only the stress on the crop needs to be ensured to be balanced in the third segment. After the third segment, the crop finishes to separate with the soil, and crop harvesting enters a next step. A height between a highest point of the crop in the third segment and a lowest point of the crop of the next step is within an allowable range of falling damage and as small as possible to prevent the crop from being damaged due to falling. After performing the speed analysis on the crop, the crop has an upward movement trend, the low-loss transport device with directed force application and slow landing is also transported upward along with an inclination angle thereof, so that the upward movement trend of the crop is buffered. The crop is kept relatively stationary with the low-loss transport device with directed force application and slow landing. In the third segment, an inclination angle between the resultant velocity direction and a horizontal direction is 90°.

$$mg sin γ - µmgcosγ = 0 \qquad Formula ( 15 )$$

$${F}_{N} - µmgcosγ = 0 \qquad Formula ( 16 )$$

$${v}_{q} - {v}_{s} cos γ = 0 \qquad Formula ( 17 )$$

$${v}_{sy 3} - {v}_{s} sin γ = 0 \qquad Formula ( 18 )$$

ν_{sy3} is a component velocity of the transporting velocity in the horizontal direction of the second segment.

After calculation, the inclination angle of the third segment satisfies following condition:

$$γ \leq arc tan μ .$$

S3.1: a motion trail of the crop is analyzed. When the crop passes through the first segment and moves into the second segment, an initial speed of the oblique projectile movement of the crop is νₕ, and an inclination angle between the initial speed of oblique projectile movement of the crop and the horizontal plane is θ.

$$tan θ = \frac{{v}_{s} sin α}{{v}_{s} cos α - {v}_{q}} \qquad Formula ( 19 )$$

$${v}_{h} = \sqrt{{( {v}_{s} sin α )}^{2}} + {( {v}_{s} cos α - {v}_{q} )}^{2} \qquad Formula ( 20 )$$

$${t}_{1} = \frac{\sqrt{{( {v}_{s} sin α )}^{2} + {( {v}_{s} cos α - {v}_{q} )}^{2}} sin ( arc tan \frac{{v}_{s} sin α}{{v}_{s} cos α - {v}_{q}} )}{g} \qquad Formula ( 21 )$$

When the crop moves to the highest point A, the crop only has a speed νₛ cos α−ν_{g} in the horizontal direction, and the crop continues to do the oblique projectile movement, magnitudes and directions of the initial speed and a final speed of the oblique projectile movement of crop depend on inclinations of the first segment and the second segment, which are not necessarily equal. An instantaneous speed of the crop falling on the low-loss transport device with directed force application and slow landing is νₕ₁, an inclination angle σ between the instantaneous speed ν₂ of the crop falling on the low-loss transport device with directed force application and slow landing and the horizontal direction is 90°, and the direction of the instantaneous speed ν₂ of the crop falling on the low-loss transport device with directed force application and slow landing is vertically downward.

$${v}_{sy 2} = {v}_{s} sin β \qquad Formula ( 22 )$$

$${v}_{h 1} = \frac{{v}_{hx}}{cos ξ} = \frac{{v}_{s} cos α - {v}_{q}}{cos ξ} \qquad Formula ( 23 )$$

$${v}_{hy} = ( {v}_{s} cos α - {v}_{q} ) tan ξ \qquad Formula ( 24 )$$

$${t}_{2} = \frac{( {v}_{s} cos α - {v}_{q} ) tan ξ}{g} \qquad Formula ( 25 )$$

$${h}_{2} = \frac{{( {v}_{s} cos α - {v}_{q} )}^{2} {tan}^{2} ξ}{2 g} \qquad Formula ( 26 )$$

According to the theoretical analysis performed in the S2, since the inclination angle σ between the instantaneous speed of the crop falling on the low-loss transport device with directed force application and slow landing and the horizontal direction is 90°, and the stress on the crop is balanced, the crop moves downward along with the low-loss transport device with directed force application and slow landing, and there is no situation that the crop rolls frontward or backward. In a next stage, an inclination angle ν₃ between and the horizontal direction is 90°, a movement direction of the crop is upward, and the stress on the crop is balanced. The upward movement trend of the crop and an upward transporting velocity of the low-loss transport device with directed force application and slow landing are buffered, the crop moves along with the low-loss transport device with directed force application and slow landing.

$${v}_{3} = {v}_{s} sin γ \qquad Formula ( 27 )$$

S3.2: the modeling main body is modeled. In order to reduce damage on the crop as much as possible, when the crop passes through the first segment and moves into the second segment, a motion radian of the low-loss transport device with directed force application and slow landing satisfies the motion trail of the crop, so that a maximum buffer effect is achieved. For another consideration, a certain tensioning force needs to be kept in each segment when the assembling the low-loss transport device with directed force application and slow landing, it is impossible to present a radian between two fixing devices of the low-loss transport device with directed force application and slow landing during normal field work, so that the motion radian of the low-loss transport device with directed force application and slow landing is achieved by providing auxiliary wheels, an outer contour curve of each of the auxiliary wheels in contact with the belts is the same as the motion trail of the crop, and the motion trail of the crop is the oblique projectile movement. The oblique projectile movement takes a throw point as a coordinate origin, an initial throw speed is νₕ, a horizontal component is in a positive direction of an X axis, a vertical component is in a positive direction of a Y axis, after being thrown out after time t, a horizontal displacement is X, and a vertical displacement is Y.

$$x = {v}_{h} t cos θ \qquad Formula ( 28 )$$

$$y = {v}_{h} t sin θ - \frac{{gt}^{2}}{2} \qquad Formula ( 29 )$$

In combination with the formula (19) and the formula (20), the time t is removed at the same time to obtain a trajectory equation:

$$y = \frac{{v}_{s} sin α}{{v}_{s} cos α - {v}_{q}} x - \frac{g}{2 [ {( {v}_{s} sin α )}^{2} + ( {v}_{s} cos α - {v}_{q} ) ] cos ( arc tan \frac{{v}_{s} sin α}{{v}_{s} cos α - {v}_{q}} )} {x}^{2} \qquad Formula ( 30 )$$

An outer contour curve of each of the auxiliary wheels in contact with the belts satisfies a condition of the formula (30).

The S4 includes following steps.

S4.1: an equation of the motion trail of the crop is obtained in combination with the theoretical analysis performed in the S2, the three-dimensional diagram is modeled by using the SolidWorks or other three-dimensional modeling software.

S4.2: the grid bars, the belts, etc. of the low-loss transport device with directed force application and slow landing are modeled, and the grid bars with the belts are assembled.

S4.3: the auxiliary wheels, the fixing wheels, the low-loss transport device with directed force application and slow landing, etc. are assembled to obtain an assembly body.

Furthermore, two belts are disposed in the low-loss transport device with directed force application and slow landing to form a belt unit, and a plurality of the grid bars are disposed on an outer side of the belt unit at equal intervals, a fixing wheel of the low-loss transport device with directed force application and slow landing is disposed at a first side of an interior of the belt unit, and a driving wheel is disposed at a second side of the interior of the belt unit away from the fixing wheel of the low-loss transport device with directed force application and slow landing.

Furthermore, the auxiliary wheels are disposed on an inner side and an outer side of the low-loss transport device with directed force application and slow landing, and a supporting surface of each of the auxiliary wheels is parallel to the belts.

Advantages of the modeling method for the low-loss transport technology with directed force application and slow landing of the present disclosure are as follows.

The modeling method for the low-loss transport technology with directed force application and slow landing effectively separates the crop with the soil and greatly reduces situations, such as high surface scratching rate and internal bruising caused due to a motion manner of a conventional low-loss transport device with directed force application and slow landing, in a separation process of the crop and the soil. A motion manner in the separation process of the crop and the soil is changed from passive dragging to directed force application and slow contact provided by the low-loss transport device with directed force application and slow landing, so that the crop moves along with the low-loss transport device with directed force application and slow landing, the crop passes through the excavating device and moves to the low-loss transport device with directed force application and slow landing and passes through the first segment to the second segment, and a transition stage from the first segment to the second segment is a main stage that the crop is damaged, the present disclosure models a transition position between the first segment and the second segment on the low-loss transport device with directed force application and slow landing according the motion trail of the crop to reduce surface scratching and internal bruising caused in the separation process of the crop and the soil at the greater extent to reduce the crop damage rate and prolong a storage period of the crop, thereby increasing incomes of users.

The above-mentioned embodiments only express several embodiments of the present disclosure, and the description thereof is more specific and detailed, but it cannot be understood as a limitation to a protection scope of the present disclosure. It should be noted that, for those who skilled in the art, several variations and improvements may be made without departing from a concept of the present disclosure, which shall all fall within the protection scope of the present disclosure. Therefore, the protection scope of the present disclosure shall be subject to the appended claims.

What is claimed is:

1. A modeling method for a low-loss transport technology with directed force application and slow landing, comprising:
S1: determining relevant parameters specified by a potato harvesting standard;
S2: performing theoretical analysis, and determining structural parameters of a low-loss transport device with directed force application and slow landing;
S3: modeling an auxiliary device for simulating a motion trail of a crop; and
S4: modeling a modeling main body, auxiliary wheels, grid bars, and belts in sequence to form a low-loss transport device with directed force application and slow landing, and modeling a driving device at a rear portion of the low-loss transport device with directed force application and slow landing to drive the low-loss transport device with directed force application and slow landing to run;
wherein the S2 comprises dividing the low-loss transport device with directed force application and slow landing into three segments to respectively perform the theoretical analysis on the crop; the theoretical analysis comprises stress analysis and speed analysis; the three segments comprise a first segment, a second segment, and a third segment, the first segment is from a front driven wheel to the modeling main body, the second segment is from the modeling main body to the auxiliary wheels, and the third segment is from the auxiliary devices to the driving device;
the stress analysis and the speed analysis are as follows:
in the first segment, a component velocity of the crop in a horizontal direction is slightly higher than a forward speed of the low-loss transport device with directed force application and slow landing, a vertical movement distance of the crop is not greater than a maximum height of falling of the crop, and stress on the crop is balanced; an inclination angle of the modeling main body of the low-loss transport technology with directed force application and slow landing is the same as an inclination angle of a digging shovel;
in the second segment, a movement of the crop from the first segment to the second segment is an oblique projectile movement, and at a moment when the crop is in contact with the low-loss transport device with directed force application and slow landing, a resultant velocity direction of the crop is vertically downward and the stress on the crop is balanced; and
in the third segment, the crop moves along with the low-loss transport device with directed force application and slow landing, the stress on the crop is balanced, and a height between a highest point of the crop in the third segment and a lowest point of the crop of a next step is within an allowable range of falling damage.

2. The modeling method for the low-loss transport technology with directed force application and slow landing according to claim 1, wherein in that at the moment when the crop is in contact with the low-loss transport device with directed force application and slow landing, the resultant velocity direction of the crop is vertically downward and the stress on the crop is balanced, a speed difference between an instantaneous resultant velocity of the crop falling on the low-loss transport device with directed force application and slow landing and a transporting velocity of the low-loss transport device with directed force application and slow landing is not greater than 0.02 m/s.

3. The modeling method for the low-loss transport technology with directed force application and slow landing according to claim 1, wherein in the stress analysis and the speed analysis performed on the second segment, the transporting velocity of the low-loss transport device with directed force application and slow landing is transported downward along an inclination angle, and plays a role in buffering the crop.

4. The modeling method for the low-loss transport technology with directed force application and slow landing according to claim 1, wherein the S3 comprises:
analyzing the motion trail of the crop; and
modeling the modeling main body.

5. The modeling method for the low-loss transport technology with directed force application and slow landing according to claim 4, wherein in the analyzing the motion trail of the crop, when the crop passes through the first segment into the second segment, the movement of the crop is the oblique projectile movement, and magnitudes and directions of an initial speed and a final speed of the oblique projectile movement depend on inclinations of the first segment and the second segment.

6. The modeling method for the low-loss transport technology with directed force application and slow landing according to claim 4, wherein in the modeling the modeling main body, when the crop passes through the first segment into the second segment, a motion radian of the low-loss transport device with directed force application and slow landing satisfies the motion trail of the crop, and the motion radian of the low-loss transport device with directed force application and slow landing is achieved by providing modeling main body auxiliary wheels, and an outer contour curve of each of the modeling main body auxiliary wheels in contact with the belts is the same as the motion trail of the crop.

7. The modeling method for the low-loss transport technology with directed force application and slow landing according to claim 6, wherein in that the motion radian of the low-loss transport device with directed force application and slow landing is achieved by providing the modeling main body auxiliary wheels, three modeling main body auxiliary wheels are provided, a diameter of an outer wheel of each of the modeling main body auxiliary wheels is less than a diameter of an outer wheel of each of the auxiliary wheels of the low-loss transport device with directed force application and slow landing.

8. The modeling method for the low-loss transport technology with directed force application and slow landing according to claim 1, wherein in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, a pitch of the driving device is 45 mm and is adapted to a pitch of the low-loss transport device with directed force application and slow landing.

9. The modeling method for the low-loss transport technology with directed force application and slow landing according to claim 1, wherein in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, two belts are disposed in the low-loss transport device with directed force application and slow landing to form a belt unit, and a plurality of the grid bars are disposed on an outer side of the belt unit at equal intervals, a fixing wheel of the low-loss transport device with directed force application and slow landing is disposed at a first side of an interior of the belt unit, and a driving wheel is disposed at a second side of the interior of the belt unit away from the fixing wheel of the low-loss transport device with directed force application and slow landing.

10. The modeling method for the low-loss transport technology with directed force application and slow landing according to claim 1, wherein in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, the auxiliary wheels are disposed on an inner side and an outer side of the low-loss transport device with directed force application and slow landing, and a supporting surface of each of the auxiliary wheels is parallel to the belts.

11. The modeling method for the low-loss transport technology with directed force application and slow landing according to claim 1, wherein in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, a trajectory formed between the auxiliary wheels is the same as a curve of a movement of the crop on a surface of the low-loss transport device with directed force application and slow landing.

12. The modeling method for the low-loss transport technology with directed force application and slow landing according to claim 1, wherein in the modeling the modeling main body, the auxiliary wheels, the grid bars, and the belts in sequence to form the low-loss transport device with directed force application and slow landing, and modeling the driving device at the rear portion of the low-loss transport device with directed force application and slow landing to drive the low-loss transport device with directed force application and slow landing to run, the grid bars are made of round steel 11/55CrSi, the belts are made of canvas filler rubber, a covering glue tensile strength of the belts is greater than or equal to 25° C., a stretching rate of the belts is greater than or equal to 500%, a Schopper abrasion of the belts is less than or equal to 100 mm³, an adhesion force of belts is greater than or equal to 10 N/M, the belts are not aged for one year under sunlight and has a pitch of 45 mm; the belts and the grid bars are connected by a pin shaft assembly in a riveting process to form the low-loss transport device with directed force application and slow landing.
